(19) United States
(12) Patent Application Publication
(10) Pub. No.: US 2006/0180614 A1
(43) Pub. Date: Aug. 17, 2006

(54) Portable collapsible container for liquids

(76) Inventors: Craig Barron, Calgary (CA); Lyndon Peacock, Calgary (CA)

Correspondence Address: ANTONY C. EDWARDS, SUITE 200 - 270 HIGHWAY 33 WEST, KELOWNA, BC, V1X 1X7, CA

(21) Appl. No.: 11/055,982

(22) Filed: Feb. 14, 2005

(51) Int. Cl. B65D 37/00; B67D 3/00

(52) U.S. Cl. 222/210; 222/215; 222/530; 222/538

(57) ABSTRACT

A collapsible and expandable container for liquids includes sidewall bellows defining collapsible and expandable side walls of a liquid impervious and preferably inert container having sealed ends. One end of the sealed ends of the container is a lid mounted on the bellows. The lid may be shaped as a tray so as to define a depression which is accessible from the outside of the container. At least one aperture is formed in said depression including a spout aperture opening into the bellows. A coupler such as a threaded neck may be formed on the aperture or apertures for re-sealable mounting of a cap and a spout thereon. The depression in the tray may be sized for flush mounting of the cap and the spout within the depression for ease of storage.

### FIELD OF THE INVENTION

This invention relates to the field of containers used to transport liquid fuel for vehicles, and in particular to a portable collapsible container for liquids.

### BACKGROUND OF THE INVENTION

This invention addresses a problem which may be encountered for example by motorists on unfamiliar back country roads or caught in congested traffic within a city, especially those motorists who use vehicles such as sport utility vehicles which consume gasoline at a high rate. The problem is that the vehicles run out of gasoline before the motorist can for example find a town in the former example or a freeway exit and hence to a gasoline refuelling station in the latter example. Typically then, the motorist must walk or get a ride with another motorist to the nearest gasoline station, borrow or rent a portable rigid gasoline container such as a so-called “jerry can”, fill the container with gasoline, return to the vehicle with the full container, decant the gasoline into the vehicle tank, and return the container to the station. In many if not most instances the station will require some form of monetary or other security to ensure the motorist will return the borrowed or rented container. Clearly this is inconvenient and an inefficient transaction from a business point of view for the parties involved. However, many motorists it would not usually make sense to carry an empty jerry can or other rigid gasoline container within the vehicle because the relatively large hollow container would use a disproportionate amount of available cargo carrying space, and would be at risk of being stolen or damaged if carried externally on the vehicle. The fuel containers would not normally have fuel in them for safety reasons if the vehicle is travelling in traffic because of the risk of fire in the event of an impact.

### SUMMARY OF THE INVENTION

Consequently, there exists a need in the prior art, and it is an object of the present invention to provide, a collapsible portable container for liquids such as liquid fuels. In its collapsed state the container may be efficiently stowed away within a vehicle while taking up a minimum of cargo storage space. In its expanded state the container may be used for transporting and decanting liquids such as fuel when needed. The container may be sold in its collapsed state by a retailer such as a gasoline station instead of loaning or renting out a conventional container.

In summary, the collapsible and expandable container for liquids according to the present invention may be characterized in one aspect as including sidewall bellows defining collapsible and expandable side walls of a liquid impervious and preferably inert container having sealed ends, wherein one end of the sealed ends of the container is a lid mounted on the bellows. The lid may be shaped as a tray so as to define a depression which is accessible from the outside of the container. At least one aperture is formed in said depression including a spout aperture opening into the bellows. A coupler such as a threaded neck may be formed on the aperture or apertures for re-sealable mounting of a cap and a spout thereon. The depression in the tray is advantageously sized for mounting of the cap and the spout within the depression, for example, completely within the depression for ease of storage.

The bellows, when collapsed, have a circumferential collapsed side-wall having a wall thickness and depth defining therein a collapsed cavity. The tray depression fits at least partially into the collapsed cavity within the circumferential collapsed side-wall when the container is in its collapsed state. The tray depression stored at least partially within the collapsed cavity between the collapsed side-walls of the bellows so as to minimize the volume of the container in its collapsed state. In its expanded state the side-wall bellows extend, for example unfold, so as to expand the container from its collapsed state into an expanded state. The substantially thin-walled container then has an expanded interior volume which is much greater than the volume of the collapsed cavity.

In one embodiment, the bellows are in the shape of a parallelepiped. The tray may be generally rectangular. The tray may have a circumferential rim mounted on an upper circumferential edge of the side-wall bellows. The depression in the tray may also be a parallelepiped.

A further selectively re-sealable second aperture may be formed in the tray depression. A corresponding cap may be provided to selectively provide an airflow into the container as fluid is decanted through the spout when the spout is mounted on to the spout aperture. The spout aperture may have a spout mounting neck offset to a first side of a centreline of the lid so as to provide space within the depression for snugly storing the spout between the spout mounting neck and a first corresponding side wall of the depression. The second aperture may have a cap mounting neck offset oppositely relative to the spout mounting neck so as to be offset on a second side of the centerline of the lid. One end of the spout releasably and snugly mounts between the cap mounting neck and a second corresponding side wall of the depression, and an opposite end of the spout releasably and snugly mounts between the spout mounting neck and the first corresponding side wall of the depression.

In one preferred embodiment the circumferential rim of the lid and the base are substantially planar and, when the container is in the collapsed state, substantially parallel. Preferably the bellows are foldable by means of pleats so as to accordion the container between the collapsed state and the expanded state. A handle may be mounted to the rigid base. The handle may be foldable so as to compactly fold flush against the base when the container is in the collapsed state.

### BRIEF DESCRIPTION OF THE DRAWINGS

FIG. 1 is, in top perspective view, the collapsible container for fluids in one embodiment of the present invention in an expanded state.

FIG. 1a is an exploded view of FIG. 1.

FIG. 2 is, in left side elevation view, the container of FIG. 1.

FIG. 3 is, in front elevation view, the container of FIG. 1.

FIG. 4 is, in top perspective view, the collapsible container of FIG. 1 in a collapsed state.

FIG. 5 is, in plan view, the collapsible container of FIG. 4.

FIG. 6 is, in front elevation view, the container of FIG. 4.

FIG. 7 is, in side elevation view, the container of FIG. 4.

FIG. 8 is, in top perspective view, an alternative embodiment of the collapsible container for fluids according to the present invention in an expanded state.

FIG. 9 is, in plan view, the container of FIG. 8.

FIG. 10 is, in top perspective view, the container of FIG. 8 in a collapsed state for storage.

FIG. 11 is, in plan view, the container of FIG. 10.

### DETAILED DESCRIPTION OF EMBODIMENTS OF THE INVENTION

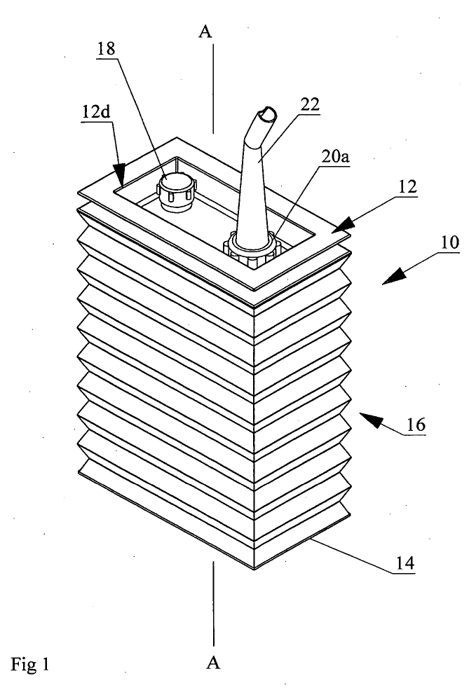

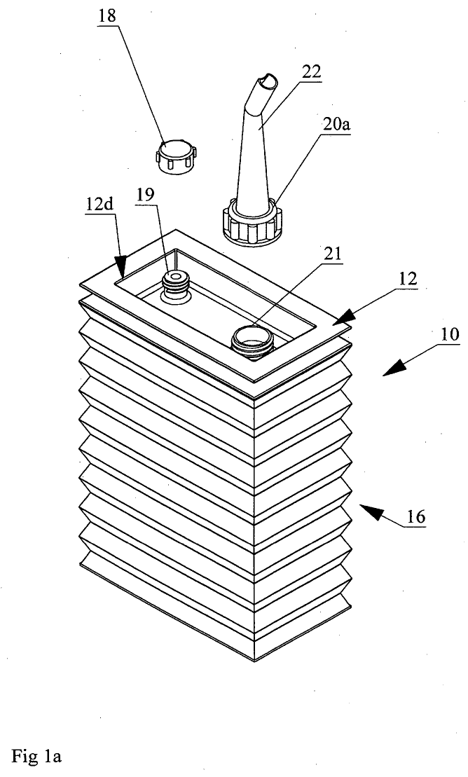

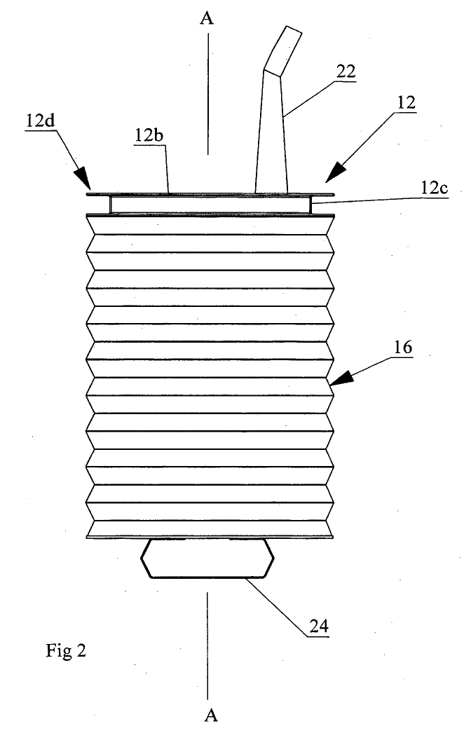

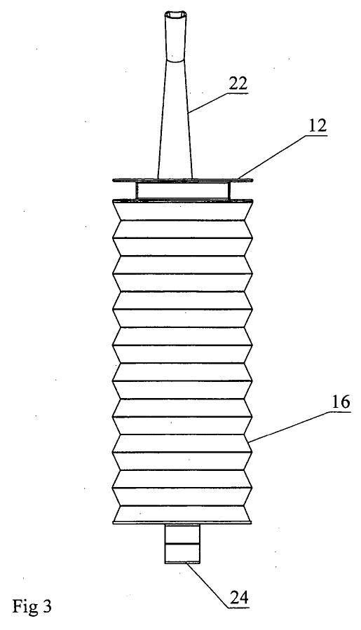

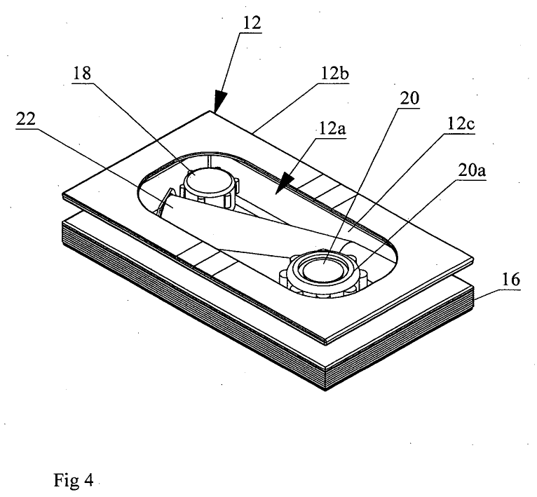

With reference to the drawings wherein similar characters of reference denote corresponding parts in each view, collapsible container for liquids 10 has a rigid cover 12, a rigid bottom plate 14 and sandwiched between cover 12 and bottom plate 14 flexible folding bellows 16. Bellows 16 are pleat folded so as to form a collapsible and expandable accordion between cover 12 and bottom plate 14 for collapsing and expansion of liquid container 10 along longitudinal axis A. In the expanded state of FIGS. 1-3, cover 12 and bottom plate 14 are spaced apart, and may remain generally parallel to each other, so as to increase the volume of the cavity defined by the hollow bellows 16. In use, the bottom plate and the cover may be pulled apart to open the pleating of bellows 16 once either or both of caps 18 and 20, the latter better seen in FIG. 4, have been removed by being unthreaded from cover 12. In convention fashion, cap 20 may be held in place on a threaded neck by means of a threaded collar 20a holding cap 20 in place down onto the threaded neck. The threaded neck on which collar 20a threads, defines an aperture into the bellows cavity within bellows 16. Similarly, the threaded neck onto which cap 18 threads, also defines an aperture into the bellows cavity.

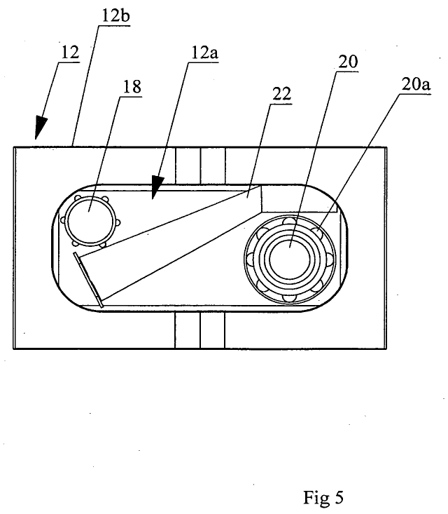

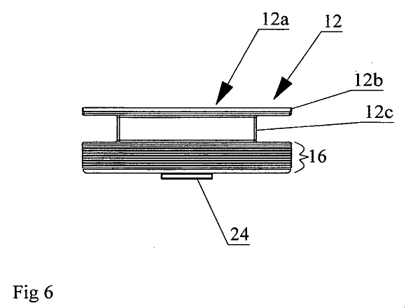

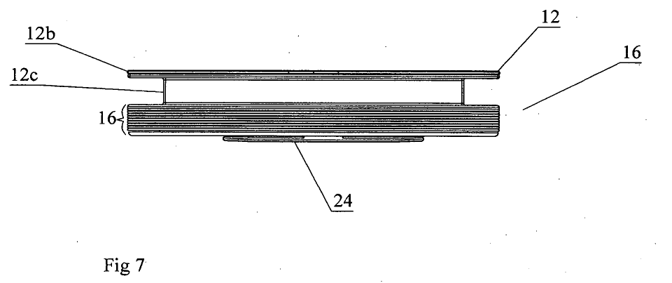

In use, liquid container 10 is stored in its collapsed state as seen in FIGS. 4-7. In both the embodiments of FIGS. 1 and 4, cover 12 is formed so as to define a trough, channel or depression, collectively herein depression 12a surrounded by circumferential rim flange 12b. Depression 12a depends downwardly from flange 12b so as to define a storage compartment in which caps 18 and 20 are recessed when mounted on their corresponding threaded necks, and wherein spout 22 may be stored conveniently by being snugly fit between the offset positioning of caps 18 and 20 and the corresponding side-walls 12c of cover 12.

In the embodiment of FIGS. 4-7, depression 12a and corresponding side-walls 12c extend between flange 12b and atop of the collapsed bellows 16. Thus in its collapsed state, fuel container 10 is only as thick as the sum of the thicknesses of flange 12b, depression 12a, bellows 16 and folding handle 24, caps 18 and 20 and spout 22 being completely stored within depression 12a.

In its collapsed state, as may be seen, liquid container 10 may be conveniently and compactly stored for example in the storage area within a vehicle or on the retail sales shelves of a gas station. In a preferred embodiment, liquid container 10 may be constructed of materials that may be either reusable, for example in a slightly more expensive embodiment, or which may be disposable, for example in a slightly less expensive embodiment, so long as the container is constructed so that it does not leak and so that its materials are substantially liquid impervious, that is, so as to be impervious from penetration by the types of liquids which may be carried for example water or liquid fuels.

With one of the caps open so as to allow air into the bellows cavity, when it is desired to use container 10 to carry liquid, cover 12 and bottom plate 14 may be either manually pulled apart or cover 12 may be supported and liquid poured into the aperture underneath cap 20, through the corresponding threaded neck, so that the weight of the liquid opens the pleating of bellows 16. Once bellows 16 are either partially open or completely unfolded so as to maximize the volume of the bellows cavity, the caps may be re-sealed onto the threaded necks and liquid container 10 then may be safely transported. For ease of handling, as an example, liquid container 10 may be lifted for pouring out of the contents through spout 22 by grasping the lip 12d formed between flange 12b and side-walls 12c of cover 12 opposite from spout 22, and handle 24 so as to tip and lift the entire container. The liquid may then be decanted manageably from spout 22.

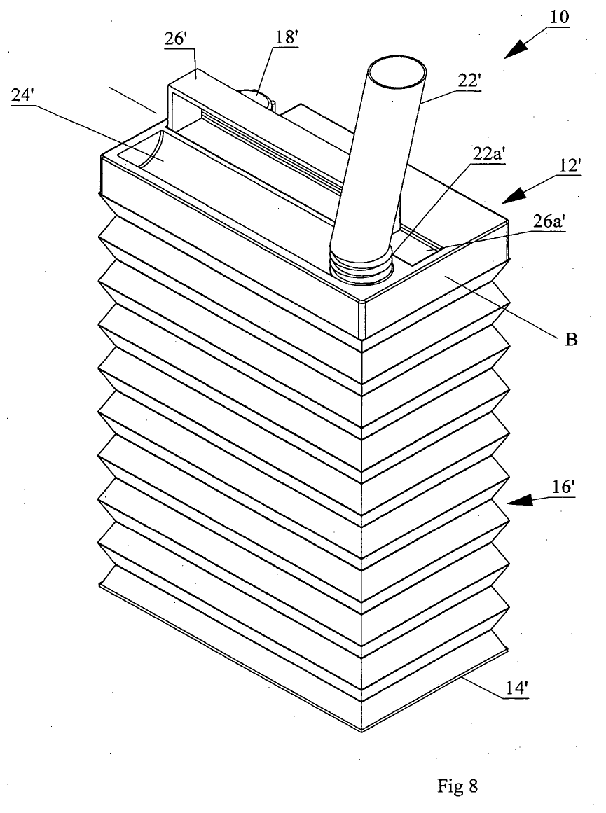

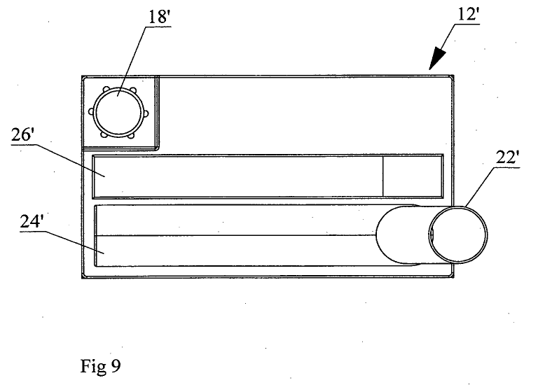

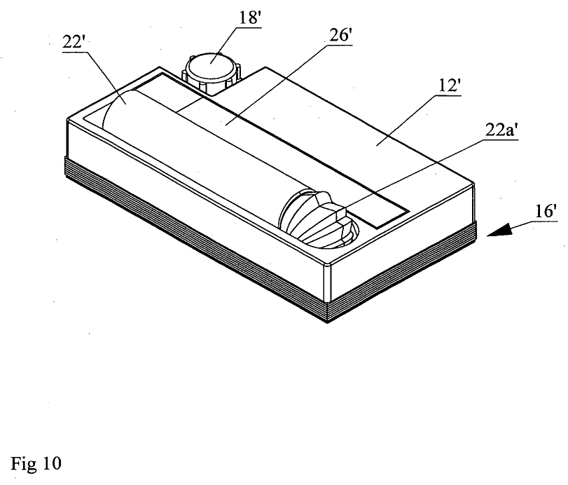

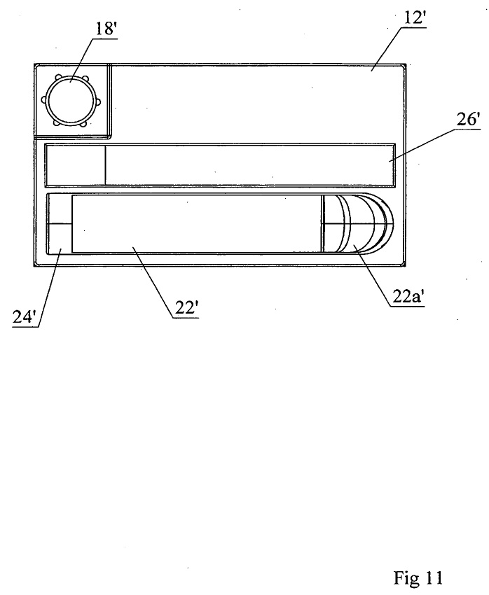

In the alternative embodiment of FIGS. 8-11, which is not intended to be limiting, a rigid lid 12′ is mounted on the upper end of hollow pleated bellows 16′. Rigid base 14′ is mounted on the opposite end of bellows 16′. Lid 12′ is formed in the shape of a tray having an elongate depression or channel 24′ in which may be stored spout 22′ when folded over into its storage position about its flexible neck 22a′. A handle 26′ may be provided along the centreline B of lid 12′ so as to provide for carrying of container 10. Advantageously, handle 26′ may be folded down so as to lie flush within channel 26a′ for storage. An air vent and cap 18′ is positioned on lid 12′ diametrically oppositely disposed to the neck 22a′ of spout 22′. Cap 18′ when mounted onto lid 12′ is recessed flush with the upper surface of the lid. Bellows 16′ may be accordioned from its expanded state into its collapsed state of FIG. 10 for ease of storage.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A collapsible and expandable container for liquids comprising:
sidewall bellows forming collapsible and expandable side walls of a liquid impervious container having sealed ends, wherein an upper end of said sealed ends includes a tray-shaped lid mounted on an upper end of said bellows, wherein said lid has a depression within which is formed at least one aperture including a spout aperture having a coupler mounted thereon for re-sealable mounting thereon of a cap and a spout, and wherein said depression in said lid is sized for mounting of a cap and a spout within said depression.

2. The device of claim 1 wherein said bellows, when in a collapsed state, form a circumferential collapsed side-wall having a wall thickness and depth defining therein a collapsed cavity, wherein said depression at least partially fits into said collapsed cavity whereby said cap and spout may be stored within said depression, and said depression stored at least partially within said collapsed cavity between said collapsed side-walls for efficient storage of the cap and spout and to minimize the volume of the container in its collapsed state, and wherein, in an expanded state said side wall bellows extend so as to expand said container from its said collapsed state into said expanded states so as to form an expanded, thin-walled hollow container having an expanded volume which is greater than the volume of said collapsed cavity.

3. The device of claim 2 wherein said bellows are generally in the shape of a parallelepiped and includes a rigid base mounted, opposite to said lid, to a lower end of said bellows.

4. The device of claim 3 wherein said lid has a circumferential rim mounted on an upper circumferential edge of said side-wall bellows.

5. The device of claim 4 wherein said depression is substantially parallelepiped-shaped.

6. The device of claim 5 further comprising a further selectively re-sealable second aperture formed in said depression and corresponding cap to selectively provide an airflow into said container as fluid is decanted through said spout when said spout is mounted on to said spout aperture.

7. The device of claim 4 wherein said circumferential rim and said base are substantially planar and, in said collapsed state, substantially parallel.

8. The device of claim 7 wherein said bellows are foldable by means of pleats so as to accordion between said collapsed state and said expanded state.

9. The device of claim 3 further comprising a handle mounted to said rigid base.

10. The device of claim 9 wherein said handle is foldable so as to compactly fold flush against said base when said container is in said collapsed state.

11. The device of claim 2 wherein said spout aperture has a spout mounting neck offset to a first side of a centreline of said lid so as to provide space within said depression for snugly storing said spout between said spout mounting neck and a first corresponding side wall of said depression.

12. The device of claim 6 wherein said spout aperture has a spout mounting neck offset to a first side of a centreline of said lid so as to provide space within said depression for snugly storing said spout between said spout mounting neck and a first corresponding side wall of said depression.

13. The device of claim 12 wherein said second aperture has a cap mounting neck offset oppositely relative to said spout mounting neck so as to be offset on a second side of said centerline of said lid and wherein one end of said spout releasably and snugly mounts between said cap mounting neck and a second corresponding side wall of said depression, and wherein an opposite end of said spout releasably and snugly mounts between said spout mounting neck and said first corresponding side wall of said depression.
